(19) United States
(12) Patent Application Publication
(10) Pub. No.: US 2023/0267340 A1
(43) Pub. Date: Aug. 24, 2023

(54) MULTI-TENANCY MACHINE-LEARNING BASED ON COLLECTED DATA FROM MULTIPLE CLIENTS

(71) Applicant: ProSOC, Inc., Carlsbad, CA (US)

(72) Inventors: Kristopher Chesney, San Diego, CA (US); Jordan Knopp, Carlsbad, CA (US)

(21) Appl. No.: 17/675,704

(22) Filed: Feb. 18, 2022

(51) Int. Cl. G06N 5/02; G06F 16/2455; G06F 16/18

(52) U.S. Cl. CPC G06N 5/022; G06F 16/24564; G06F 16/1805

(57) ABSTRACT

Embodiments of the disclosure are related to a method, apparatus, and system for multi-tenancy machine-learning based on collected data from multiple clients, comprising: obtaining client data from multiple clients; sending the client data from the multiple clients to a database; pulling data from the database by a machine learning job based on job parameters; partitioning the data by each client for the machine learning job; analyzing the data from the multiple clients by the machine learning job; sending the results of the analysis of the data from the multiple clients by the machine learning job back to the database; querying the database for data specified by rules; and if rules are met by the queried data for one or more of the multiple clients, transmit an alert to an alerting platform.

### FIELD

Embodiments of the disclosure are related to computer networks, and more particularly, to multi-tenancy machine-learning based on collected data from multiple clients.

### RELEVANT BACKGROUND

Computer networks and systems have become indispensable tools for modern business. Today terabits of information on virtually every subject imaginable are stored in and accessed across such networks by users throughout the world. Much of this information is, to some degree, confidential and its protection is required. Not surprisingly, various network security monitoring systems have been developed to help uncover attempts by unauthorized persons and/or devices to gain access to computer networks and the information stored therein.

Unfortunately, many current network security monitoring systems are inefficiently implemented.

### BRIEF DESCRIPTION OF THE DRAWINGS

FIG. 1 is a flowchart illustrating an example method for multi-tenancy machine-learning based on collected data from multiple clients in a computer network, according to one embodiment of the disclosure.

FIG. 2 is a block diagram illustrating an overall structure of a method, apparatus, and system for multi-tenancy machine-learning based on collected data from multiple clients in a computer network, according to one embodiment of the disclosure.

FIG. 3 is a block diagram illustrating an overall structure of a method, apparatus, and system for multi-tenancy machine-learning based on collected data from multiple clients in a computer network, according to one embodiment of the disclosure.

FIG. 4 is a block diagram illustrating an example implementation of the method, apparatus, and system for multi-tenancy machine-learning based on collected data from multiple clients in a computer network, according to one embodiment of the disclosure.

FIG. 5 is a block diagram illustrating an example implementation of the method, apparatus, and system for multi-tenancy machine-learning based on collected data from multiple clients in a computer network, according to one embodiment of the disclosure.

FIG. 6 is a block diagram illustrating an example computing device, according to embodiments of the disclosure.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments. Embodiments of disclosure described herein may relate to functionality implemented across multiple devices. Obvious communications (e.g., transmissions and receipts of information) between the devices may have been omitted from the description in order not to obscure the disclosure.

Embodiments of the disclosure are related to a method, apparatus, and system for multi-tenancy machine-learning based on collected data from multiple clients in a computer network. In one embodiment, the method, apparatus, and system allows a single machine learning job to be created that can be run against all the client data from multiple clients in a computer network in a multi-tenant database. An analysis across all the client data is run simultaneously by the single machine learning job, while maintaining a separation of client data. This is opposed to prior art techniques in which the same learning job is duplicated for each client and each duplicated learning job is performed against only one client's data.

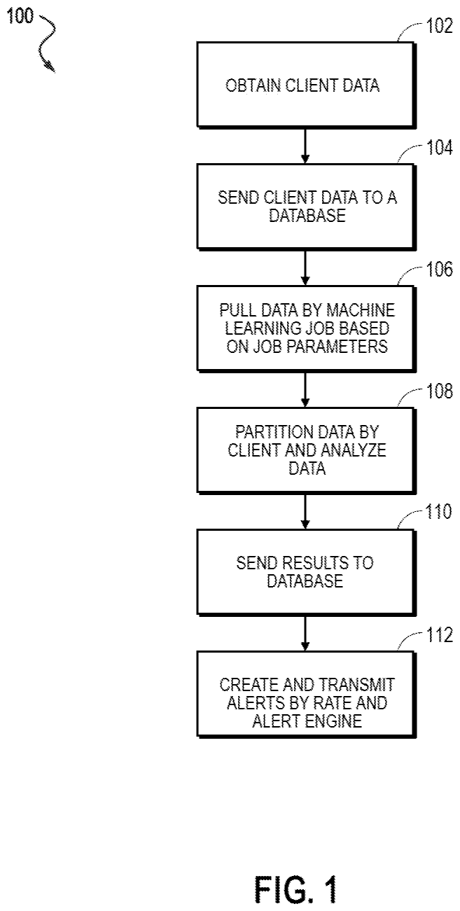

Referring to FIG. 1, FIG. 1 is a flowchart 100 illustrating an example method for multi-tenancy machine-learning based on collected data from multiple clients in a computer network, according to one embodiment of the disclosure.

At block 102, client data is obtained from multiple clients. At block 104, the client data from the multiple clients is sent to a database. Next, at block 106, data from the database is pulled by a machine learning job based on job parameters. At block 108, the data from the multiple clients is partitioned by each client within the machine learning job and, further, the data from each client is analyzed by the machine learning job. Next, at block 110, the results of the analysis of the data are sent from the multiple clients by the machine learning job back to the database. At block 112, the database is queried for data specified by rules, and if rules are met by the queried data for one or more of the multiple clients, create and transmit an alert to an alerting platform. More detailed implementations of the embodiments will be discussed hereafter.

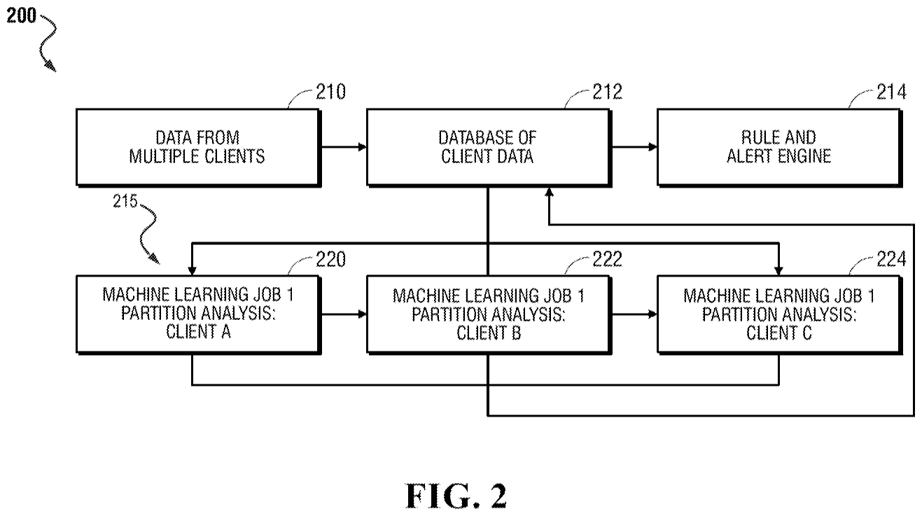

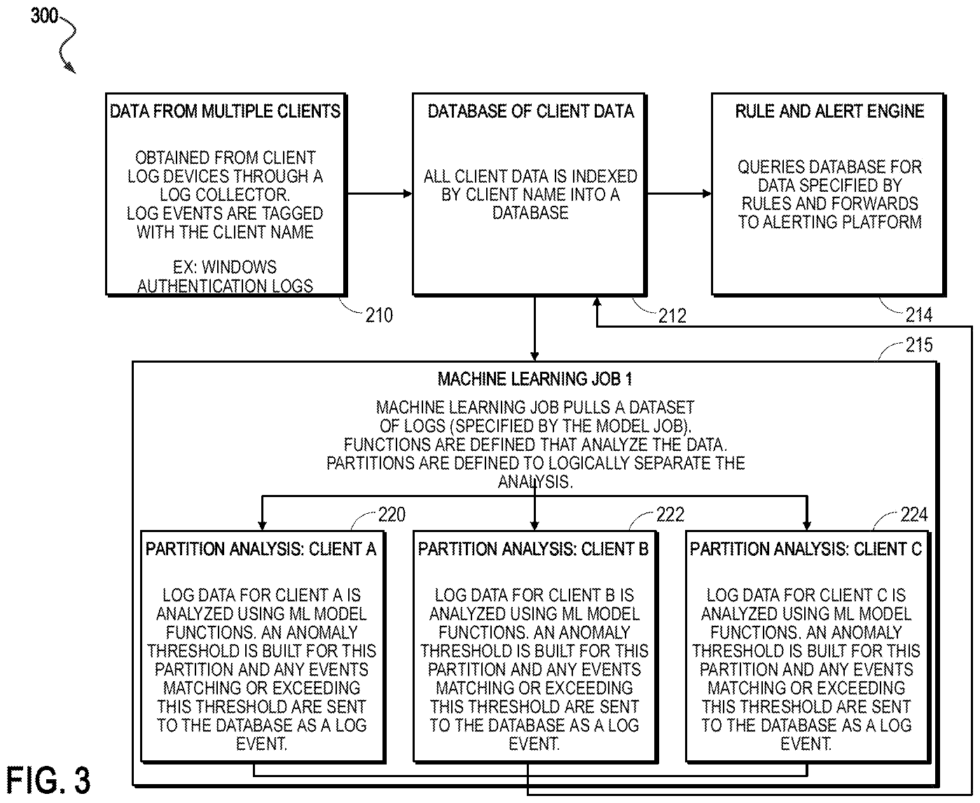

Referring to FIGS. 2 and 3, block diagrams 200, 300 illustrate an overall structure of a method, apparatus, and system for multi-tenancy machine-learning based on collected data from multiple clients in a computer network, according to one embodiment of the disclosure.

For example, with reference to FIG. 2, data from multiple clients 210 is obtained. The client data from the multiple clients is sent to a database to create a database of client data 212. A machine learning job 215 (in this example, including partitions for client A 220, client B 222, client C 224) pulls data from the database 212 based on job parameters. As can be seen, the data from the multiple clients is partitioned by each client within the machine learning job 215 (e.g., partition client A 220, partition client B 222, partition client C 224). The data from each client that is pulled by the machine learning job (e.g., denoted machine learning job 1) is analyzed by the machine learning job for each client partition (e.g., partition client A 220, partition client B 222, partition client C 224). The results of the analysis of the data by the machine learning job 215 (for each of the client partitions A, B, C 220, 222, 224) for each of the multiple clients are sent by the machine learning job back to the database of client data 212. Rule and Alert Engine 214 may query the database of client data 212 for data specified by rules. If the rules are met by the queried data for one or more of the multiple clients (e.g., client A, B, C), the Rule and Alert Engine 214 may create and transmit an alert to an alerting platform. The alerting platform may alert the client as to the findings of the Rule and Alert Engine 214. More detailed implementations of the embodiments will be discussed hereafter.

In another further example, with reference to FIG. 3, data from multiple clients 210 is obtained. In one embodiment, the client data 210 obtained from the multiple clients is obtained through a log collector from client log devices. As an example, window authentication logs. In one embodiment, log events from the client data obtained from the multiple clients through the log collector are tagged with a client name. This client data 210 is sent and stored at the database of client data 212. In particular, in this example, the client log data is stored in the database of client data with an organized structure. For example, the client data obtained from the multiple clients including log events tagged with client names is indexed by client name in the database of client data 212. Therefore, in this example, all client data is indexed by client name into a database.

Continuing with this example, a machine learning job 215 (in this example, including partitions for client A 220, client B 222, client C 224) pulls data from the database of log events 212 based on job parameters. In particular, in this embodiment, the machine learning job 215 retrieves data from the database of log events 212 and analyzes the data. In this embodiment, the machine learning job 215 pulls a data set of log events, specified by the model job. In particular, functions are defined that analyze the data and partitions are defined to logically separate the analysis. The machine learning job 215 is built to retrieve a specific data set and apply specific algorithms, depending on the specific use case required. The machine learning job 215 partitions the analysis by client to allow for enhanced capability and refinement.

As can be seen, the data from the multiple clients is partitioned by the machine learning job 215 (e.g., partition client A 220, partition client B 222, partition client C 224). The data from the multiple clients that is pulled by the machine learning job (e.g., denoted machine learning job 1) is analyzed by the machine learning job for each client partition (e.g., partition client A 220, partition client B 222, partition client C 224). In one example embodiment, the machine learning job 215 retrieves data from the database of log events 212 and the machine learning job 215 analyzes the data from the database of log events. The data from the multiple clients that is pulled by the machine learning job 1 215 is analyzed by the machine learning job for each client partition (e.g., partition client A 220, partition client B 222, partition client C 224).

As can be seen for partition analysis client A 220, log event data for client A is analyzed using a machine learning (ML) model function and an anomaly threshold is built for the partition and any events matching or exceeding this threshold are sent back to the database of client log events 212 as a log event. Similarly, for partition analysis client B 222, log event data for client B is analyzed using a machine learning (ML) model function and an anomaly threshold is built for the partition and any events matching or exceeding this threshold are sent back to the database of client log events 212 as a log event. Furthermore, for partition analysis client C 224, log event data for client C is analyzed using a machine learning (ML) model function and an anomaly threshold is built for the partition and any events matching or exceeding this threshold are sent back to the database of client log events 212 as a log event. Therefore, the machine learning job 215 analyzes the data from the database of log events 212 and, based on the analysis of the data from the database of log events, determines if an anomaly has occurred, wherein, an anomaly occurs when a log event matches or exceeds, a predefined threshold. In particular, if an anomaly occurs, a new log event for the client is sent back to the database of log events 212, including the client name and data about the original event.

Rule and Alert Engine 214 may query the database of log events 212 for data specified by rules. If the rules are met by the queried data for one or more of the multiple clients (e.g., client A, B, C), the Rule and Alert Engine 214 may create and transmit an alert to an alerting platform. The alerting platform may alert the client as to the findings of the Rule and Alert Engine 214. In one embodiment, after, a new log event for the client is sent back to the database of log events 212, the new log event for the client is analyzed by the alert rule, and if the conditions of the alert rule are met, an alert is sent to an alerting platform. The alerting platform may alert the client as to the findings of the Rule and Alert Engine 214. More detailed implementations of the embodiments will be discussed hereafter.

Therefore, the machine learning job 215 operates as a singular machine learning job, wherein the singular machine learning job 215 analyzes the data from the database of log events for each of the clients of the multiple clients, in a partitioned manner, such that each of the log events for each client are analyzed separately, and, based on the analysis of the data from the database of log events for each client, the machine learning job determines if an anomaly has occurred, for each client.

One benefit of the previously described implementation is that it allows for the application of a single Machine Learning Job use case across several clients rather than having to create multiple custom Machine Learning Jobs based on the same use case for each client. This translates into ease of operation and gained efficiencies in processing cost. Further, since all events are partitioned by client, and then analyzed separately, there is no need to be concerned about events from different clients mixing to dilute the accuracy and effectiveness of a Machine Learning Job for each client.

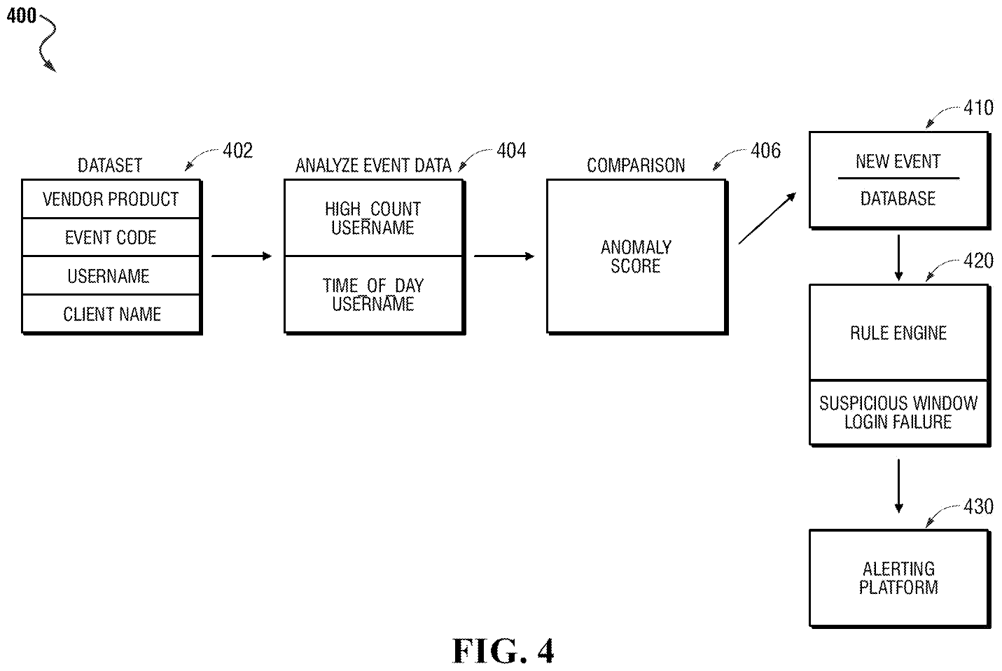

With reference to FIG. 4, FIG. 4 is a block diagram 400 illustrating an example implementation of the method, apparatus, and system for multi-tenancy machine-learning based on collected data from multiple clients in a computer network, according to one embodiment of the disclosure. In this example, the machine learning job 215 retrieves a specific dataset (block 402) from the database of client data 212. In this example, the specific dataset includes a vendor product, an event code, a username, and a client name. For example: Vendor_product=Microsoft Windows, Event_code=4625, Username, Client Name.

As an example, based on this specific dataset, the machine learning job 215 at block 404 analyzes the specific event data by several algorithms for a predetermined period of time (e.g., 5 minutes). In this example, a High_count by username is partitioned by the client name. In particular, the machine learning job performs an analysis for the partitioned client name and the number of events for a specific username is tracked to compare to a typical number of events for that username. Further, in this example, a Time_of_day by username is partitioned by the client name. In particular, the machine learning job performs an analysis for the partitioned client name and the time of day for these events for a username and this is tracked to compare to the typical time of day that these events occur. The results of these analyses are compared to a stored baseline for that client at block 406. At block 406, an anomaly score is assigned to this analysis of events based on how far the results deviate from the baseline score. When an anomaly score is assigned, a new event is created that is labeled with the client name and a summary of the anomalous events. At block 410, this new event is sent to the database 212 to be stored. Further, at block 420, the rule and alert engine 214 looks for a new “Suspicious Windows Login Failure” event to be created with an anomaly score above a certain threshold. Once that threshold is met, at block 430, the information is sent to an Alerting Platform.

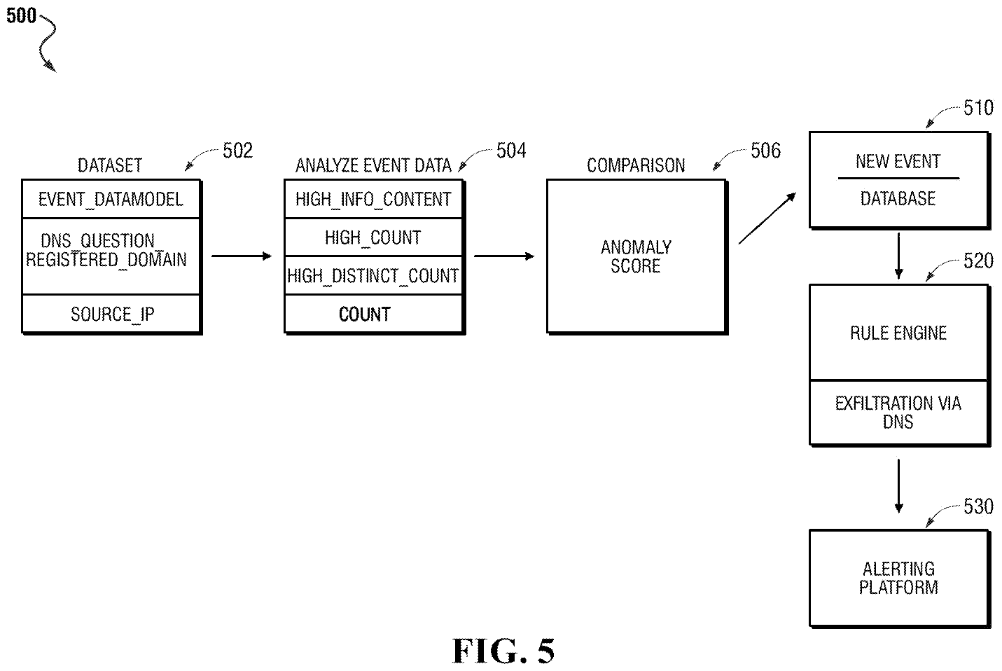

With reference to FIG. 5, FIG. 5 is a block diagram 500 illustrating an example implementation of the method, apparatus, and system for multi-tenancy machine-learning based on collected data from multiple clients in a computer network, according to one embodiment of the disclosure. In this example, the machine learning job 215 retrieves a specific dataset (block 502) from the database of client data 212. In this example, the specific dataset includes: Event_datamodel=Network Resolution; DNS_Question_Registered_Domain; and Source_ip.

As an example, based on this specific dataset, the machine learning job 215 at block 504 analyzes the specific event data by several algorithms for a predetermined period of time (e.g., 10 minutes). In this example, the High_info_content of “DNS_Question_Registered_Domain” by “source_ip” is partitioned by client name. In particular, the machine learning job performs an analysis in which the amount of content within the registered domain is tracked to compare to a typical content size for domains by that source_ip. Further, High_count of “DNS_Question_Registered_Domain” over “source_ip” is partitioned by client name. In particular, the machine learning job performs an analysis in which the number of times domains are logged for a specific ip is tracked to compare to the typical number of times that domains are seen over all source_ip

Moreover, High_distinct_count of “DNS_Question_Registered_Domain” over “source_ip” is partitioned by client name. In particular, the machine learning job performs an analysis in which the number of times a specific registered domain was seen is tracked to compare that to the typical number of times that domains were seen by that source_ip. Furthermore, count of “source_ip” by “source_ip” is partitioned by client name. In particular, the machine learning job performs an analysis in which the number of times a specific source_ip has made DNS requests is tracked to compare that to a typical number of times for that source_ip.

The results of these analyses are compared to a stored baseline for that client at block 506. At block 506, an anomaly score is assigned to this analysis of events based on how far the results deviate from the baseline score. When an anomaly score is assigned, a new event is created that is labeled with the client name and a summary of the anomalous events. At block 510, this new event is sent to the database 212 to be stored. Further, at block 520, the rule and alert engine 214 looks for a new “Exfiltration via DNS” event to be created with an anomaly score above a certain threshold. Once that threshold is met, at block 530, the information is sent to an Alerting Platform.

It should be appreciated that these are just examples of implementations of the method, apparatus, and system for multi-tenancy machine-learning based on collected data from multiple clients in a computer network, according to embodiments of the disclosure. As previously described, a single Machine Learning Job may be built with specific goals based upon specific inputs (e.g., user login from rare geolocation). The dataset for this may include event logs across all client logs (e.g., event.name=Login, user.name exists, geolocation exists, etc.). In these ways, a Machine Learning Model may be created to partition all data by a certain field, then run the model function within each partition (e.g., partition field=client name). Further, rare geolocation analysis may be run and tracked within individual client partitions. When an anomaly is found within that client partition, then the event is logged and sent back to the client's database of log events. This allows Alerting to be created by client name based on anomalies found.

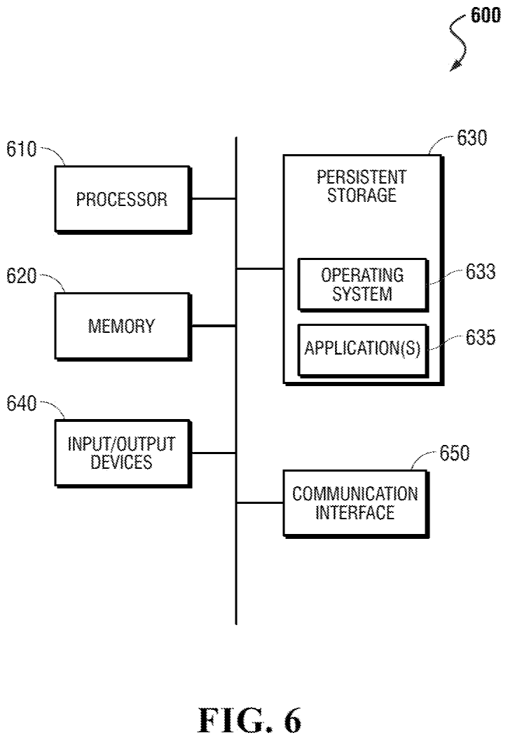

Referring to FIG. 6, a block diagram illustrating an example computing device 600 according to embodiments of the disclosure is shown. The device may comprise a processor 610, a memory 620, a persistent storage 630, one or more input/output devices 640, and a communication interface 650. The memory 620 may comprise a random access memory (RAM) and a read-only memory (ROM). An operating system 633 and one or more applications 635 may be stored in the persistent storage 630. The code stored in the persistent storage 630 may be loaded into the memory 620 and executed by the processor 610. When code is executed by the processor 610, the device 600 may perform one or more functions based on the code, such as the operating system 633 or the applications 635. The one or more applications 635 may be adapted for various functions and purposes. The communication interface 650 may enable the device 600 to communicate with one or more other devices using one or more known wired or wireless communication protocols.

Merely by way of example, one or more procedures described with respect to the method(s) previously described may be implemented as code and/or instructions executable by a device (and/or a processor within a device). A set of these instructions and/or code may be stored on a non-transitory computer-readable storage medium, such as the persistent storage device(s) 630 described above. In some cases, the storage medium might be incorporated within a computer system, such as the device 600. In other embodiments, the storage medium might be separate from the devices (e.g., a removable medium, such as a compact disc), and/or provided in an installation package, such that the storage medium can be used to program, configure, and/or adapt a computing device with the instructions/code stored thereon. These instructions might take the form of executable code, which is executable by the device 600 and/or might take the form of source and/or installable code, which, upon compilation and/or installation on the device 600 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, firmware, software, or combinations thereof, to implement embodiments described herein. Further, connection to other computing devices such as network input/output devices may be employed.

It should be appreciated that aspects of the previously described processes may be implemented in conjunction with the execution of instructions by a processor (e.g., processor 610) of a device (e.g., device 600), as previously described. Particularly, circuitry of the devices, including but not limited to processors, may operate under the control of a program, routine, or the execution of instructions to execute methods or processes in accordance with embodiments described (e.g., the processes and functions of FIGS. 1-5). For example, such a program may be implemented in firmware or software (e.g. stored in memory and/or other locations) and may be implemented by processors and/or other circuitry of the devices. Further, it should be appreciated that the terms device, processor, microprocessor, circuitry, controller, SoC, etc., refer to any type of logic or circuitry capable of executing logic, commands, instructions, software, firmware, functionality, etc.

It should be appreciated that when the devices are wireless devices that they may communicate via one or more wireless communication links through a wireless network that are based on or otherwise support any suitable wireless communication technology. For example, in some aspects the wireless device and other devices may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, 3G, LTE, LTE Advanced, 4G, 5G, CDMA, TDMA, OFDM, OFDMA, WiMAX, Wi-Fi, Bluetooth, Zigbee, LoRA, and Narrowband-IoT (NB-IoT). Similarly, a wireless device may support or otherwise use one or more of a variety of corresponding modulation or multiplexing schemes. A wireless device may thus include appropriate components (e.g., communication subsystems/interfaces (e.g., air interfaces)) to establish and communicate via one or more wireless communication links using the above or other wireless communication technologies. For example, a device may comprise a wireless transceiver with associated transmitter and receiver components (e.g., a transmitter and a receiver) that may include various components (e.g., signal generators and signal processors) that facilitate communication over a wireless medium. As is well known, a wireless device may therefore wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a virtual reality or augmented reality device, a personal data assistant (“PDA”), a tablet, a wearable device, an Internet of Things (IoT) device, a mobile computer, a laptop computer, an entertainment device (e.g., a music or video device), a headset (e.g., headphones, an earpiece, etc.), a medical device (e.g., a biometric sensor, a heart rate monitor, a pedometer, an EKG device, etc.), a user I/O device, a computer, a wired computer, a fixed computer, a desktop computer, a server, a point-of-sale device, a set-top box, or any other type of computing device. These devices may have different power and data requirements.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, firmware, or combinations of both. To clearly illustrate this interchangeability of hardware, firmware, or software, various illustrative components, blocks, modules, circuits, and steps have been described above generally in terms of their functionality. Whether such functionality is implemented as hardware, firmware, or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA), a system on a chip (SoC), or other programmable logic device, discrete gate or transistor logic, discrete hardware components, or any combination thereof designed to perform the functions described herein. A general purpose processor may be a microprocessor or may be any type of processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in firmware, in a software module executed by a processor, or in a combination thereof. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

What is claimed is:

1. A method for multi-tenancy machine-learning based on collected data from multiple clients comprising:
obtaining client data from multiple clients;
sending the client data from the multiple clients to a database;
pulling data from the database by a machine learning job based on job parameters;
partitioning the data by each client for the machine learning job;
analyzing the data from the multiple clients by the machine learning job;
sending the results of the analysis of the data from the multiple clients by the machine learning job back to the database;
querying the database for data specified by rules; and
if rules are met by the queried data for one or more of the multiple clients, transmit an alert to an alerting platform.

2. The method of claim 1, wherein the client data obtained from the multiple clients is obtained through a log collector.

3. The method of claim 2, wherein log events from the client data obtained from the multiple clients through a log collector are tagged with a client name.

4. The method of claim 2, wherein log events from the client data obtained from the multiple clients through a log collector are tagged with a client name and the client data obtained from the multiple clients is indexed by client name in the database.

5. The method of claim 4, wherein the machine learning job retrieves data from the database of log events.

6. The method of claim 5, wherein the machine learning job partitions the data by each client and analyzes the data from the database of log events.

7. The method of claim 5, wherein the machine learning job partitions the data by each client and analyzes the data from the database of log events and, based on the analysis of the data from the database of log events, determines if an anomaly has occurred, wherein, an anomaly occurs when a log event matches or exceeds, a predefined threshold.

8. The method of claim 7, wherein, if an anomaly occurs, a new log event for the client is sent back to the database, including the client name and data about the original event.

9. The method of claim 8, wherein, after, the new log event for the client is sent back to the database, the new log event for the client is analyzed by an alert rule, and if the conditions of the alert rule are met, an alert is sent to an alerting platform to be sent to the client.

10. The method of claim 7, wherein, the machine learning job operates as a singular machine learning job, wherein the singular machine learning job analyzes the data from the database of log events for each of the clients of the multiple clients, in a partitioned manner, such that each of the log events for each client are analyzed separately, and, based on the analysis of the data from the database of log events for each client, the machine learning job determines if an anomaly has occurred, for each client.

11. A non-transitory computer-readable medium comprising code which, when executed by a processor, causes the processor to execute a method for multi-tenancy machine-learning based on collected data from multiple clients comprising:
obtaining client data from multiple clients;
sending the client data from the multiple clients to a database;
pulling data from the database by a machine learning job based on job parameters;
partitioning the data by each client for the machine learning job;
analyzing the data from the multiple clients by the machine learning job;
sending the results of the analysis of the data from the multiple clients by the machine learning job back to the database;
querying the database for data specified by rules; and
if rules are met by the queried data for one or more of the multiple clients, transmit an alert to an alerting platform.

12. The non-transitory computer-readable medium of claim 11, wherein the client data obtained from the multiple clients is obtained through a log collector.

13. The non-transitory computer-readable medium of claim 12, wherein log events from the client data obtained from the multiple clients through a log collector are tagged with a client name.

14. The non-transitory computer-readable medium of claim 12, wherein log events from the client data obtained from the multiple clients through a log collector are tagged with a client name and the client data obtained from the multiple clients is indexed by client name in the database.

15. The non-transitory computer-readable medium of claim 14, wherein the machine learning job retrieves data from the database of log events.

16. The non-transitory computer-readable medium of claim 15, wherein the machine learning job partitions the data by each client and analyzes the data from the database of log events.

17. The non-transitory computer-readable medium of claim 15, wherein the machine learning job partitions the data by each client and analyzes the data from the database of log events and, based on the analysis of the data from the database of log events, determines if an anomaly has occurred, wherein, an anomaly occurs when a log event matches or exceeds, a predefined threshold.

18. The non-transitory computer-readable medium of claim 17, wherein, if an anomaly occurs, a new log event for the client is sent back to the database, including the client name and data about the original event.

19. The non-transitory computer-readable medium of claim 18, wherein, after, the new log event for the client is sent back to the database, the new log event for the client is analyzed by an alert rule, and if the conditions of the alert rule are met, an alert is sent to an alerting platform to be sent to the client.

20. The non-transitory computer-readable medium of claim 17, wherein, the machine learning job operates as a singular machine learning job, wherein the singular machine learning job analyzes the data from the database of log events for each of the clients of the multiple clients, in a partitioned manner, such that each of the log events for each client are analyzed separately, and, based on the analysis of the data from the database of log events for each client, the machine learning job determines if an anomaly has occurred, for each client.
